(19) United States
(12) Patent Application Publication
(10) Pub. No.: US 2022/0322395 A1
(43) Pub. Date: Oct. 6, 2022

(54) APPENDED UPLINK CONTROL CHANNEL RESOURCE SET FOR UPLINK CONTROL CHANNEL REPETITION

(71) Applicant: QUALCOMM Incorporated, San Diego, CA (US)

(72) Inventors: Mahmoud TAHERZADEH BOROUJENI, San Diego, CA (US); Juan MONTOJO, San Diego, CA (US); Tao LUO, San Diego, CA (US); Junyi LI, Fairless Hills, PA (US); Wooseok NAM, San Diego, CA (US); Jing SUN, San Diego, CA (US)

(21) Appl. No.: 17/711,929

(22) Filed: Apr. 1, 2022

Related U.S. Application Data
(60) Provisional application No. 63/170,415, filed on Apr. 2, 2021.
(60) Provisional application No. 63/170,420, filed on Apr. 2, 2021.

(51) Int. Cl. H04W 72/12; H04L 5/00

(52) U.S. Cl. CPC H04W 72/1268; H04W 72/1278; H04W 72/1231; H04L 5/0053

(57) ABSTRACT

Certain aspects of the present disclosure provide techniques for control channel repetition and control information transmission on a data channel. One aspect provides a method for wireless communication by a user-equipment (UE). The method generally includes receiving, from a base station (BS), a scheduling of a control channel resource set for transmission of an uplink control channel repetition; determining whether the uplink control channel repetition using the control channel resource set will be dropped; and transmitting, to the BS, the uplink control channel repetition on another control channel resource set based on the determination.

### CROSS REFERENCE TO RELATED APPLICATIONS

This application claims benefit of and priority to U.S. Provisional Patent Application Nos. 63/170,420, filed on Apr. 2, 2021, and 63/170,415, filed on Apr. 2, 2021, which are assigned to the assignee hereof and herein incorporated by reference in their entirety as if fully set forth below and for all applicable purposes.

### INTRODUCTION

Aspects of the present disclosure relate to wireless communications, and more particularly, to techniques for control channel repetition.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a base station (BS). The method generally includes transmitting, to a user-equipment (UE), a scheduling of a control channel resource set for transmission of an uplink control channel repetition; determining whether the uplink control channel repetition using the control channel resource set will be dropped; and receiving, from the UE, the uplink control channel repetition on another control channel resource set based on the determination.

One aspect provides a method for wireless communication by a UE. The method generally includes receiving, from a BS, a scheduling of a control channel resource set for transmission of an uplink control channel repetition; determining whether the uplink control channel repetition using the control channel resource set will be dropped; and transmitting, to the BS, the uplink control channel repetition on another control channel resource set based on the determination.

One aspect provides a method for wireless communication by a BS. The method generally includes determining that a scheduled transmission of uplink control information (UCI) on an uplink control channel will be dropped; and receiving, from a UE, at least a portion of the UCI on an uplink data channel based on the determination.

One aspect provides a method for wireless communication by a UE. The method generally includes determining that a scheduled transmission of UCI on an uplink control channel will be dropped; and transmitting, to a BS, at least a portion of the UCI on an uplink data channel based on the determination.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 is a flow diagram illustrating example operations for wireless communication by a base station, in accordance with certain aspects of the present disclosure.

FIG. 5 is a flow diagram illustrating example operations for wireless communication by a user-equipment, in accordance with certain aspects of the present disclosure.

FIGS. 6 and 7 illustrate example scenarios resulting in collision of resources scheduled for uplink signaling, in accordance with certain aspects of the present disclosure.

FIG. 8 illustrates transmission of uplink control channel repetition on alternative resources due to reception of cancellation indication, in accordance with certain aspects of the present disclosure.

FIG. 9 is a flow diagram illustrating example operations for wireless communication by a base station, in accordance with certain aspects of the present disclosure.

FIG. 10 is a flow diagram illustrating example operations for wireless communication by a user-equipment, in accordance with certain aspects of the present disclosure.

FIGS. 11 and 12 illustrate example scenarios resulting in collision of resources scheduled for uplink signaling, in accordance with certain aspects of the present disclosure.

FIG. 13 illustrates transmission of uplink control channel repetition on a data channel due to reception of cancellation indication, in accordance with certain aspects of the present disclosure.

FIG. 14 depicts aspects of example communications devices.

### DETAILED DESCRIPTION

Aspects of the present disclosure provide apparatuses, methods, processing systems, and computer-readable mediums for transmission of uplink control channel repetition.

Certain transmissions, such as uplink control channels, may be sent with repetition to improve coverage and increase reliability. In some scenarios, however, a scheduled uplink control channel repetition may be dropped. For example, a scheduled uplink control channel repetition may be dropped due to a collision (e.g., overlapping) of resources with some other scheduled uplink signaling (e.g., another uplink control channel) or an express cancellation of the repetition via downlink control information. In such cases, the dropping of the uplink control information repetition may adversely impact communication efficiency.

Some aspects of the present disclosure are directed to techniques for handling scenarios where transmission of the uplink control channel repetition will be dropped. For example, a UE may transmit all or part of scheduled uplink control channel repetitions on an alternative uplink control channel resource set. A resource set generally refers to a set of (e.g., physical) resources (e.g., within a specific area in a time and frequency resource grid) used to carry a control channel. When the original uplink control channel resource set is configured for the repetition, an alternative uplink control channel resource set may be configured. The alternative uplink control channel resource set may be used as a backup resource in case the uplink control channel repetition on the originally configured uplink control channel resource set is dropped.

Some aspects of the present disclosure are directed to techniques for handling scenarios where a scheduled transmission of UCI on an uplink control channel will be dropped. For example, a UE may transmit all or part of the uplink control channel repetition as uplink control information on an uplink data channel. Thus, instead of completely dropping a repetition, the repetition may be transmitted on a data channel, enhancing communication efficiency. One potential benefit of these approaches is that reliability and resilience may be improved for data transmission between a transmitting user equipment (UE) and a network entity (e.g., a base station such as a gNB).

### Introduction to Wireless Communication Networks

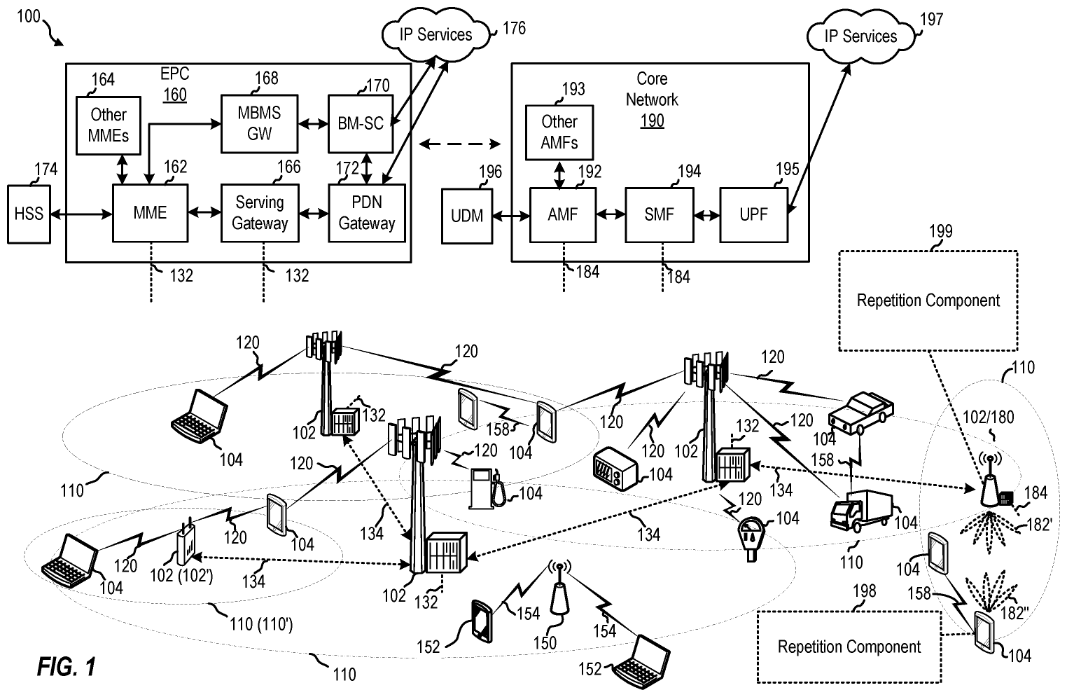

FIG. 1 depicts an example of a wireless communications system 100, in which aspects described herein may be implemented.

Generally, the wireless communications system 100 includes base stations (BSs) 102, user equipments (UEs) 104, an Evolved Packet Core (EPC) 160, and core network 190 (e.g., a 5G Core (5GC)), which interoperate to provide wireless communications services.

Base stations 102 may provide an access point to the EPC 160 and/or core network 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

The wireless communication network 100 includes a repetition component 199, which may be configured to communicate an uplink control channel repetition on alternative resources. The wireless communication network 100 further includes a repetition component 198, which may be used configured to communicate an uplink control channel repetition on alternative resources.

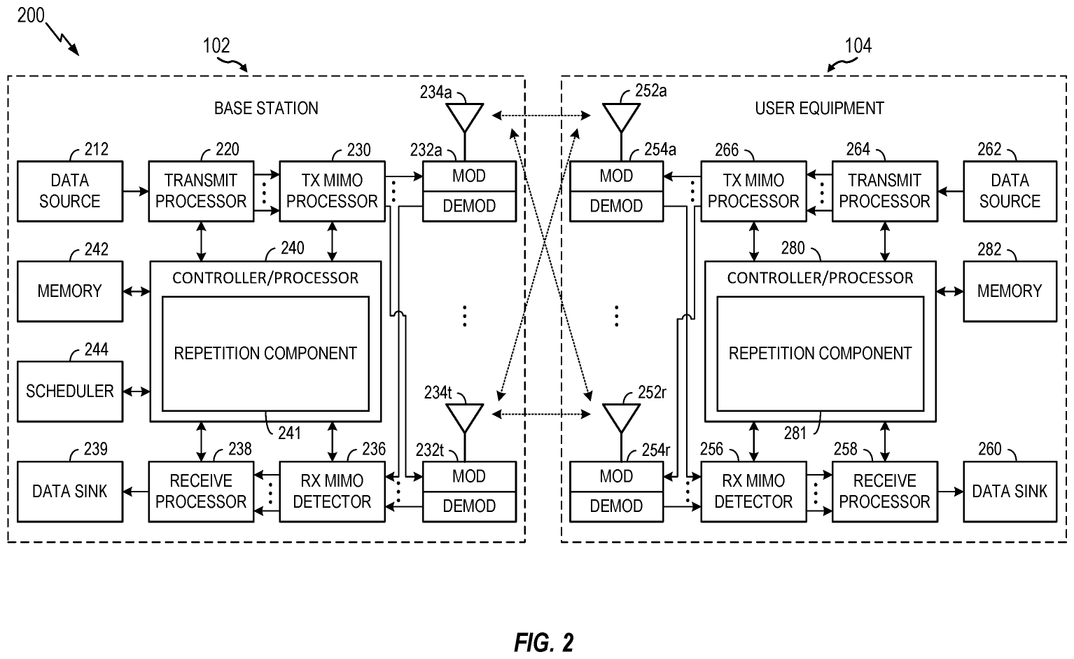

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes uplink control information component 241, which may be representative of repetition component 199 of FIG. 1. Notably, while depicted as an aspect of controller/processor 240, uplink control information component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes uplink control information component 281, which may be representative of repetition component 198 of FIG. 1. Notably, while depicted as an aspect of controller/processor 280, uplink control information component 281 may be implemented additionally or alternatively in various other aspects of user equipment 104 in other implementations.

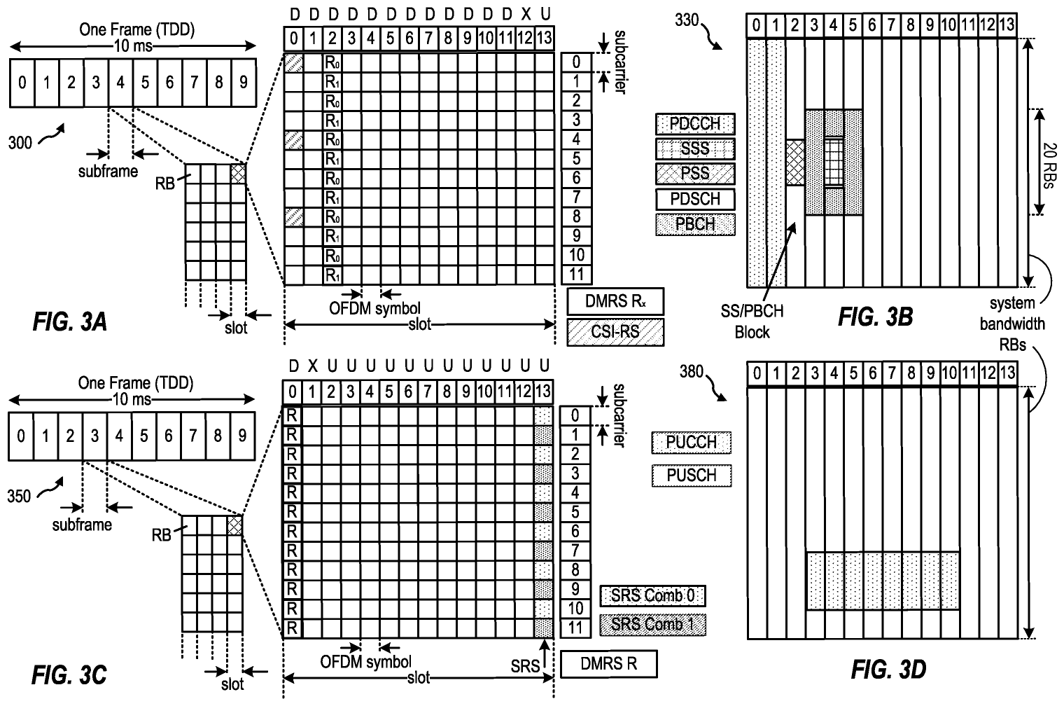

FIGS. 3A-3D depict aspects of data structures for a wireless communication network, such as the wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Uplink Control Channel Repetition on an Uplink Data Channel

Some aspects of the present disclosure are directed to coverage enhancement techniques for an uplink control channel (e.g., a physical uplink control channel (PUCCH)). A signaling mechanism may be used to support a dynamic indication of an uplink control channel repetition factor. The uplink control channel repetition factor may be included in downlink control information (DCI). The uplink control channel repetition factor may indicate whether a control channel should be repeated, as well as other information such as the number of repetitions to be used. In some implementations, DMRS bundling across control channel repetitions may be used to enhance coverage.

Uplink control channel repetition (e.g., with dynamic indication) may collide with other uplink signaling resources (e.g., for another uplink control channel). In other words, the resources scheduled for an uplink control channel repetition may at least partially overlap with resources of other uplink signaling. As a result, the scheduled uplink control channel repetition may be dropped.

An uplink control channel repetition may also be dropped for other reasons. For instance, DCI may be used by a BS to cancel a scheduled uplink control channel repetition. Cancellation indication allows a BS to cancel uplink resources of enhanced mobile broadband (eMBB) UEs via a group-common DCI to reduce interference to a higher priority communication by another UE (e.g., an ultra-reliable low-latency communication by the other UE).

Some aspects of the present disclosure are directed to techniques for handling scenarios where transmission of the uplink control channel repetition may be dropped due to, for example, collision of the uplink control channel repetition with other uplink signaling or cancellation of the uplink control channel repetition. For example, a UE may transmit all or part of one or more configured uplink control channel repetitions on alternative resources. In other words, the UE may allocated an uplink control channel resource set (e.g., referred to as an “original uplink control channel resource set”) for transmission of the uplink control channel repetition, as well as an alternative uplink control channel resource set that may be used in case the transmission of the repetition on the original uplink control channel resource set is dropped. Some aspects of the present disclosure are directed to techniques for handling scenarios where a scheduled transmission of UCI on an uplink control channel will be dropped. For example, a UE may transmit all or part of the uplink control channel repetition as UCI on an uplink data channel.

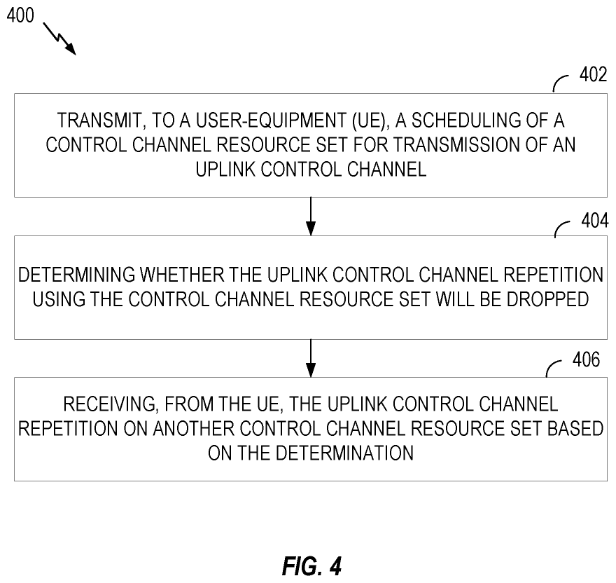

FIG. 4 is a flow diagram illustrating example operations 400 for wireless communication, in accordance with certain aspects of the present disclosure. The operations 400 may be performed, for example, by a BS (e.g., such as the BS 102 in the wireless communication network 100).

Operations 400 may be implemented as software components that are executed and run on one or more processors (e.g., controller/processor 240 of FIG. 2). Further, the transmission and reception of signals by the BS in operations 400 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 400 may begin, at block 402, with the BS transmitting, to a UE, a scheduling of a control channel resource set for transmission of an uplink control channel repetition. At block 404, the BS may determine whether the uplink control channel repetition using the control channel resource set will be dropped. At block 406, the BS may receive, from the UE, the uplink control channel repetition on another control channel resource set based on the determination.

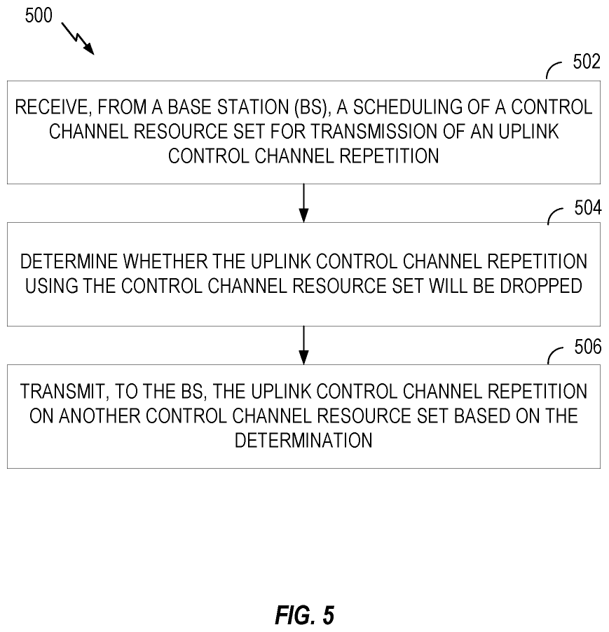

FIG. 5 is a flow diagram illustrating example operations 500 for wireless communication, in accordance with certain aspects of the present disclosure. The operations 500 may be performed, for example, by a UE (e.g., such as a UE 104 in the wireless communication network 100).

The operations 500 may be complimentary operations by the UE to the operations 400 performed by the BS. Operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 begin, at block 502, with the UE receiving, from a BS, a scheduling of a control channel resource set for transmission of an uplink control channel repetition. In some aspects, the uplink control channel repetition may provide acknowledgment (ACK) or negative ACK (NACK) for a downlink data channel. The downlink data channel may be configured using semi-persistent scheduling (SPS). In some aspects, the UE may receive downlink control information (DCI) configuring the uplink control channel repetition.

At block 504, the UE may determine whether the uplink control channel repetition using the control channel resource set will be dropped. In some aspects, the determining of whether the uplink control channel repetition will be dropped may include determining whether the uplink control channel repetition will overlap with resources scheduled for another uplink transmission. The other uplink transmission may include ACK or NACK for a data channel configured using SPS.

In some cases, the UE may receive, from the B S, an indication of cancellation of the uplink control channel repetition. The determining of whether the uplink control channel repetition will be dropped may include determining whether the uplink control channel repetition has been cancelled based on the indication from the BS.

At block 506, the UE may transmit, to the BS, the uplink control channel repetition on another control channel resource set (e.g. also referred to herein as an alternative control channel resource set) based on the determination. In some aspects, the received scheduling of the control channel resource set may indicate a mapping of the control channel resource set to the other control channel resource set. The other control channel resource set may be in the same slot as the control channel resource set. In some implementations, the other control channel resource set may be scheduled for periodic channel state information (CSI) reporting. For example, the UE may receive DCI indicating a configuration for the uplink control channel repetition, the DCI further indicating the periodical CSI reporting to be used (e.g., indicates the periodic CSI reporting, allowing the UE to use the uplink control channel resource set configured for the CSI reporting as the alternative uplink control channel resource set).

In some aspects, the UE may receive a group-common DCI addressed to multiple UEs. The group-common DCI may configure the other control channel resource set for transmission of uplink control channel repetitions by the multiple UEs.

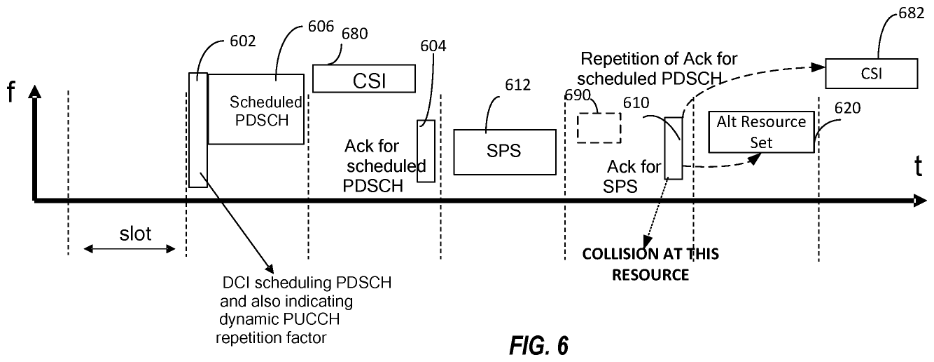

In some cases, transmission on alternative resource set may be used only for repetitions whose transmission are dropped. For example, the uplink control channel repetition transmitted on other uplink control channel resource set may be one of multiple uplink control channel repetitions. The UE may receive scheduling of the multiple uplink control channel repetitions, and at least one other uplink control channel repetition of the multiple uplink control channel repetitions may be transmitted based on the received scheduling. The operations 500 are described in more detail with respect to FIGS. 6, 7, and 8.

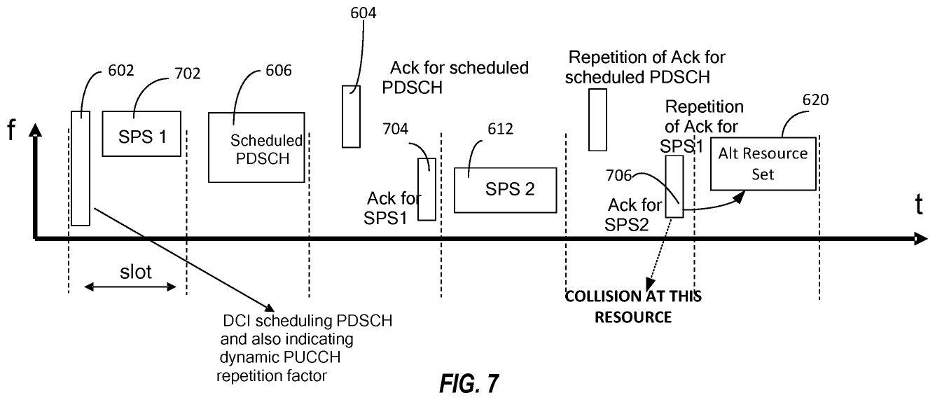

FIGS. 6 and 7 illustrate example scenarios resulting in collision of resources scheduled for uplink signaling, in accordance with certain aspects of the present disclosure. As shown in FIG. 6, a UE may receive DCI 602 which schedules a downlink data channel 606 (e.g., PDSCH), and may also include a dynamic uplink control channel (e.g., PUCCH) repetition factor for the downlink data channel 606. For example, the DCI 602 may indicate whether an uplink control channel 604 (e.g., PUCCH) used to provide ACK or ACK for downlink data channel 606 is to be repeated (e.g., as well as a number of repetitions to be used). If repetition for uplink control channel 604 is activated, resources 610 may be configured for the repetition. Moreover, one or more SPS transmissions (e.g., PDSCH) may be preconfigured via radio resource control (RRC) signaling. For example, the UE may receive the SPS transmission 612, and the uplink control channel (e.g., PUCCH) for ACK or NACK of the SPS transmission 612 may also be configured using resources 610. In other words, the resources configured for the repetition of uplink control channel 604 and ACK/NACK for SPS transmission 612 may collide. As a result, the resources 610 may be used for the ACK/NACK for the SPS transmission 612, and the repetition of uplink control channel 604 may be transmitted on an alternative control channel resource set 620, as described herein.

As shown in FIG. 7, a UE may be configured with multiple SPS configurations. For example, the UE may receive the SPS transmission 702 and transmit an uplink control channel 704 for ACK/NACK for the SPS transmission 702. The resources 706 may be configured for both the repetition of the uplink control channel 704 and the ACK/NACK for the SPS transmission 612. Therefore, due to the collision of resources scheduled for the repetition of the uplink control channel 704 and ACK/NACK for the SPS transmission 612, the repetition of the uplink control channel 704 may be transmitted on an alternative uplink control channel resource set 620.

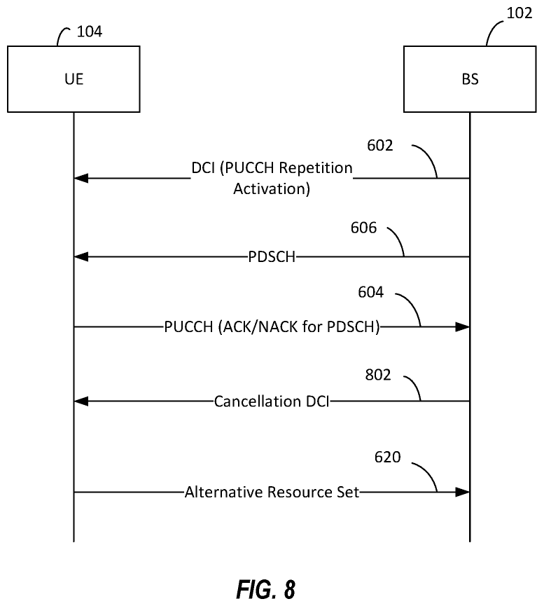

While FIGS. 6 and 7 have provided examples of scenarios where a PUCCH repetition may be dropped due to collision to facilitate understanding, the aspects described herein may be applied for other scenarios that may cause a UE to drop a scheduled transmission of uplink control channel repetition on uplink control channel resources. For example, the UE may receive a cancellation DCI, as described in more detail with respect to FIG. 8.

FIG. 8 illustrates transmission of an uplink control channel repetition on an alternative uplink control channel resource set due to reception of cancellation DCI, in accordance with certain aspects of the present disclosure. As shown, the UE may receive the DCI 602 scheduling reception of downlink data channel 606. The UE may also transmit an uplink control channel 604 for ACK/NACK of the downlink data channel 606. The DCI 602 may activate repetition for the uplink control channel 604, but the UE may receive DCI 802 canceling transmission of the uplink control channel repetition on the scheduled (original) uplink control channel resources. Thus, the UE may forgo transmitting the repetition on the original uplink control channel resources, and instead, transmit the uplink control channel on the alternative uplink control channel resource set 620, as described.

In some aspects, a UE may transmit all or part of uplink control channel repetitions (e.g., demanded by dynamic uplink control channel repetition factor (e.g., in DCI 602)) on an alternative uplink control channel resource set. The alternative uplink control channel resource set may be linked to the original uplink control channel resource set (e.g., indicated by an uplink control channel resource indicator (e.g., PUCCH resource indicator (PRI)) of the scheduling DCI), based on the configuration of the original uplink control channel resource set. In other words, RRC signaling may be used to configure uplink control channel resource sets for transmission of uplink control channel repetitions. Each of the configured uplink control channel resource sets may be mapped to an alternative uplink control channel resource set. The DCI 602 may be used to indicate one of the uplink control channel resource sets to be used for transmission of an uplink control channel repetition. If the UE determines that the uplink control channel repetition will be dropped on the original uplink control channel resource set, the UE may use the corresponding alternative uplink control channel resource set.

In some aspects, the alternative uplink control channel resources may be in the same slot as the original uplink control channel resource set. For instance, the original uplink control channel resource set, and the alternative uplink control channel resource set may provide intra-slot repetition for an uplink control channel. In other words, referring back to FIG. 6, resources 690 that are in the same slot as resources 610 may be configured as the alternative uplink control channel resource set.

The alternative uplink control channel resource set may be used only for repetitions whose transmissions are dropped on the original uplink control channel resource set. The dropping of transmissions of uplink control channel repetitions on the original resource set may be because of collision with another uplink control channel, or the dropping of transmissions of uplink control channel repetitions on the original resource set may be because of cancellation indication (e.g., cancelling uplink (UL) transmission for eMBB communication, as described herein).

In some aspects, the BS may share the alternative uplink control channel resources (for repetition) among multiple UEs (e.g., indicated separately by each RRC, or indicated by a group-common indication). For example, the BS may transmit RRC signaling to multiple UEs, and configure the same alternative resource set for transmission of an uplink control channel repetition for the multiple UEs. In some cases, the BS may use a group-common DCI to allocate the alternative control channel resource set for the multiple UEs. A group-common DCI generally refers to DCI that is addressed to multiple UEs.

In some aspects, the alternative uplink control channel resource set for uplink control channel repetition may be from resources assigned for a periodic CSI report. In this case, the uplink control channel repetitions (e.g., for ACK/NACK of a scheduled downlink data channel) may be transmitted instead of CSI report on those instances of periodic CSI. The associated periodic CSI (or its associated uplink control channel resource set) may be indicated by the DCI (e.g. DCI 602) that indicates the dynamic uplink control channel repetition factor. For example, referring back to FIG. 6, CSI resources 680, 682 may be allocated for periodic CSI reporting. In some aspects, the resource 682 may be designated as the alternative uplink control channel resource set to be used for transmission of the uplink control channel repetition in the event of a drop, as described.

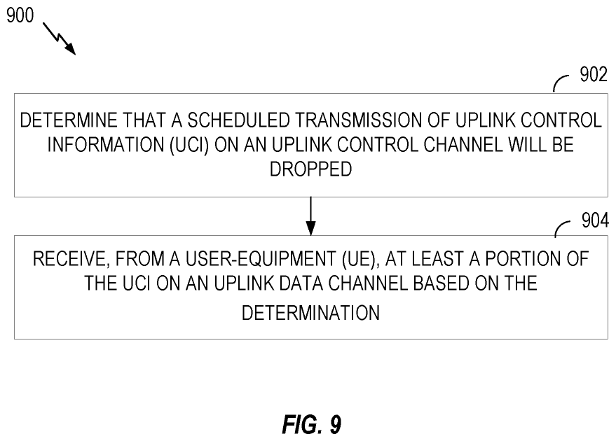

FIG. 9 is a flow diagram illustrating example operations 900 for wireless communication, in accordance with certain aspects of the present disclosure. The operations 900 may be performed, for example, by a BS (e.g., such as the BS 102 in the wireless communication network 100).

Operations 900 may be implemented as software components that are executed and run on one or more processors (e.g., controller/processor 240 of FIG. 2). Further, the transmission and reception of signals by the BS in operations 400 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 900 may begin, at block 902, with the BS determining that a scheduled transmission of uplink control information (UCI) on an uplink control channel will be dropped. At block 904, the BS may receive, from a UE, at least a portion of the UCI on an uplink data channel based on the determination.

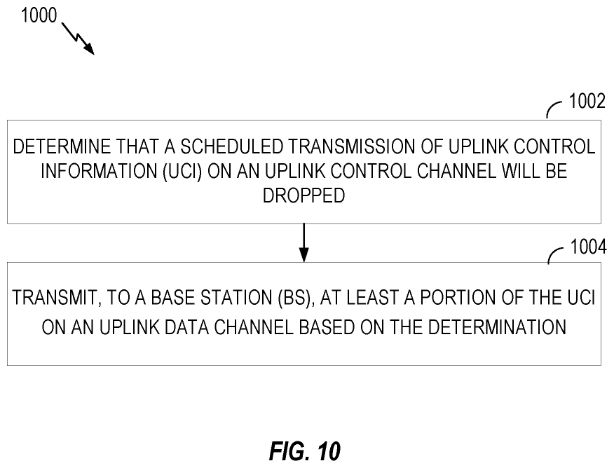

FIG. 10 is a flow diagram illustrating example operations 1000 for wireless communication, in accordance with certain aspects of the present disclosure. The operations 1000 may be performed, for example, by a UE (e.g., such as a UE 104 in the wireless communications system 100).

The operations 1000 may be complimentary operations by the UE to the operations 900 performed by the BS. Operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1000 begin, at block 1002, with the UE determining that a scheduled transmission of UCI on an uplink control channel will be dropped. In some aspects, the UCI may include a repetition of another UCI. The UCI may provide acknowledgment (ACK) or negative ACK (NACK) for a downlink data channel (e.g., PDSCH). The downlink data channel may be configured using semi-persistent scheduling (SPS).

In some aspects, the determining that the scheduled transmission will be dropped may include determining that the UCI scheduled on the uplink control channel will overlap with resources scheduled for another uplink transmission. The other uplink transmission may include ACK or NACK for a data channel configured using SPS.

In some aspects, the UE may receive, from the BS, an indication of cancellation of the scheduled transmission of the UCI. The determining that the scheduled transmission will be dropped may include determining that the scheduled transmission of the UCI has been cancelled based on the indication from the BS.

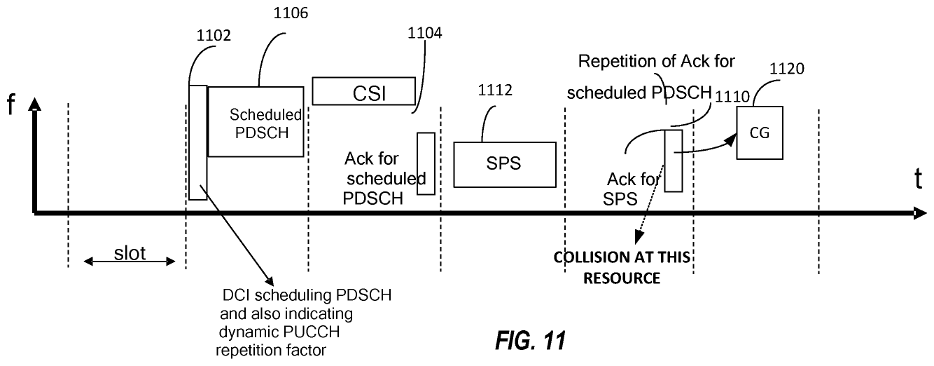

At block 1004, the UE transmits, to a BS, at least a portion of the UCI on an uplink data channel based on the determination. In some aspects, the uplink data channel may be configured using a configured grant. The operations 1000 are described in more detail with respect to FIGS. 11, 12, and 13.

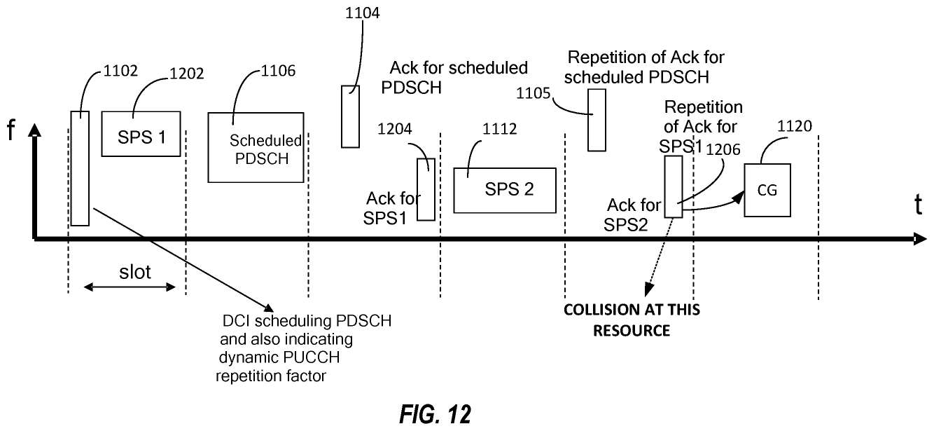

FIGS. 11 and 12 illustrate example scenarios resulting in collision of resources scheduled for uplink signaling, in accordance with certain aspects of the present disclosure. As shown in FIG. 11, a UE may receive DCI 1102 which schedules a downlink data channel 1106 (e.g., PDSCH), and may also include a dynamic uplink control channel (e.g., PUCCH) repetition factor for the downlink data channel 1106. For example, the DCI 1102 may indicate whether an uplink control channel 1104 (e.g., PUCCH) used to provide ACK or ACK for downlink data channel 1106 is to be repeated (e.g., as well as a number of repetitions to be used). If repetition for uplink control channel 1104 is activated, resources 1110 may be configured for the repetition. Moreover, one or more SPS transmissions (e.g., PDSCH) may be preconfigured via RRC signaling. For example, the UE may receive the SPS transmission 1112, and the uplink control channel (e.g., PUCCH) for ACK or NACK of the SPS transmission 1112 may also be configured using resources 1110. In other words, the resources configured for the repetition of uplink control channel 1104 and ACK/NACK for SPS transmission 1112 may collide. As a result, the resources 1110 may be used for the ACK/NACK for the SPS transmission 1112, and the repetition of uplink control channel 1104 may be transmitted on a uplink data channel 1120 (e.g., physical uplink shared channel (PUSCH)) configured using a configured grant. A configured grant generally refers to a configuration of resources for uplink data channel transmissions using RRC signaling.

As shown in FIG. 12, a UE may be configured with multiple SPS configurations. For example, the UE may receive the SPS transmission 1202 and transmit an uplink control channel 1204 for ACK/NACK for the SPS transmission 1202. The resources 1206 may be configured for both the repetition of the uplink control channel 1204 and the ACK/NACK for the SPS transmission 1112. Therefore, due to the collision of resources scheduled for the repetition of the uplink control channel 1204 and ACK/NACK for the SPS transmission 1112, the repetition of the uplink control channel 1204 may be transmitted on the uplink data channel 1120, as described. Moreover, as shown, an uplink control channel 1105 may be transmitted for repetition of the uplink control channel 1104.

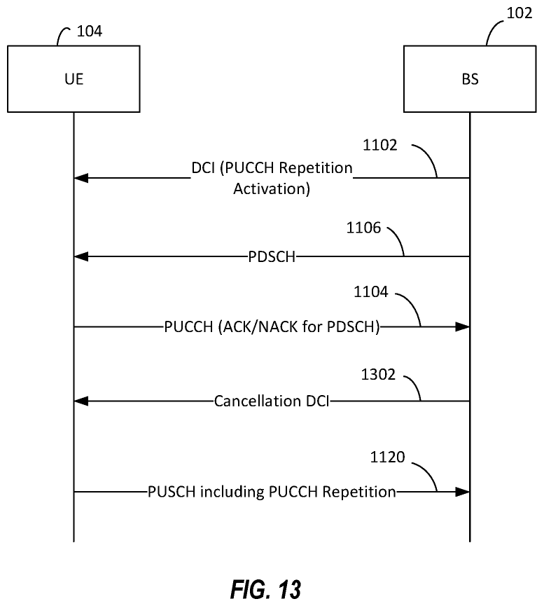

While FIGS. 11 and 12 have provided examples of scenarios where a PUCCH repetition may be dropped due to collision to facilitate understanding, the aspects described herein may be applied for other scenarios that may cause a UE to drop a scheduled transmission of uplink control channel repetition on uplink control channel resources. For example, the UE may receive a cancellation DCI, as described in more detail with respect to FIG. 13.

FIG. 13 illustrates transmission of uplink control channel repetition on an uplink data channel due to reception of cancellation DCI, in accordance with certain aspects of the present disclosure. As shown, the UE may receive the DCI 1102 scheduling reception of downlink data channel 1106. The UE may also transmit an uplink control channel 1104 for ACK/NACK of the downlink data channel 1106. The DCI 1102 may activate repetition for the uplink control channel 1104, but the UE may receive DCI 1302 canceling transmission of the uplink control channel repetition on the scheduled uplink control channel resources. Thus, the UE may transmit the uplink control channel on the uplink data channel 1120, as described.

In some aspects, the configured grant (e.g., for uplink data channel 1120) may be linked to an original uplink control channel (e.g., PUCCH) resource set (e.g., indicated by an uplink control channel resource indicator (PRI) of the scheduling DCI), based on the configuration of the original uplink control channel resource set. For example, the UE may receive RRC signaling indicating a set of uplink control channel resources, each of the set of uplink control channel resources being mapped to a configured grant. The UE may also receive DCI (e.g., DCI 1102) identifying one of the uplink control channel resources for the uplink control channel repetition. The uplink data channel (e.g., uplink data channel 1120) may be associated with the configured grant mapped to the identified uplink control channel resource.

In some aspects, a beta value may be indicated via DCI (e.g., DCI 1102) for transmission of the uplink control channel repetition on the uplink data channel 1120. The beta value may indicate a transmission power to be used for the uplink control channel repetition on the uplink data channel 1120. As described, the beta value may be indicated in the DCI that indicates the repetition factor (e.g., implicitly or explicitly). The beta value may be preconfigured as part of a configuration of the associated uplink control channel resource set (e.g., the resource set which a PRI indicates) or as part of an enhanced PRI. In other words, RRC signaling may be used to preconfigure uplink control channel resource sets, which are candidates for uplink control channel repetition transmissions. Each of the uplink control channel resource sets may be mapped to a beta value. Thus, the DCI 1102 may identify one of the uplink control channel resource sets to be used for the uplink control channel repetition using an index of the uplink control channel resource set. Based on the identified uplink control channel resource set, the UE may determine the beta value to be used when transmitting the PUCCH repetition on uplink data channel 1120. In some cases, the beta value may be preconfigured as part of a configuration of the configured grant. In other words, the configuration for the configured grant (e.g., in RRC signaling) may also indicate the beta value to be used when transmitting an uplink control channel repetition on the uplink data channel for the configured grant.

In some aspects, the transmission of the uplink control channel repetition as UCI on uplink data channel 1120 (e.g., for a configured grant) may be used only for repetitions having dropped transmission on the original uplink control channel resource set. In other words, if there are multiple uplink control channel repetitions configured and only one of the uplink control channel repetitions is dropped, only the dropped uplink control channel repetition may be transmitted on an uplink data channel for a configured grant (e.g., uplink data channel 1120). The dropping of transmission of uplink control channel repetitions on the originally scheduled resource set (e.g., resources 1110) may be because of collision with another uplink control channel or a cancellation indication (e.g., cancellation DCI 1302), as described herein.

Transmission of the uplink control channel repetition as UCI on an uplink data channel (e.g., for a configured grant) may be on an alternative specific part of the configured grant's resources (e.g., different from regular UCI on an uplink data channel) to avoid multiplexing with other UCI on the uplink data channel (e.g., for the configured grant). In other words, the uplink data channel 1120 may include another UCI (e.g., referred to herein as a regular UCI) that may be used for other purposes such as a scheduling request (SR) or ACK/NACK of another signaling. The uplink control channel repetition may be transmitted as UCI on the uplink data channel 1120 using different resources than the regular UCI resources. Transmitting the uplink control channel repetition on uplink data channel 1120 may result in a change in rate matching for the uplink data channel 1120 of the configured grant.

### Example Wireless Communication Devices

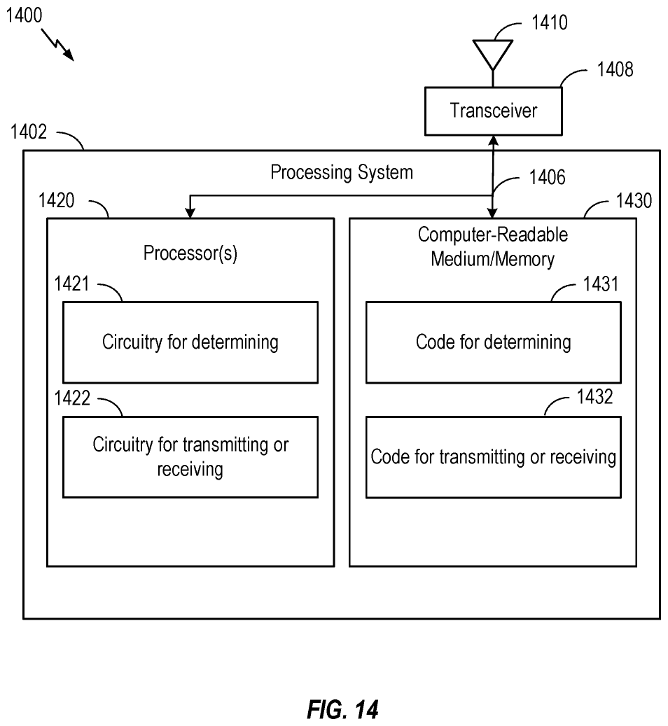

FIG. 14 depicts an example communications device 1400 that includes various components operable, configured, or adapted to perform operations for the techniques disclosed herein, such as the operations depicted and described with respect to FIGS. 4-13. In some examples, communication device 1400 may be a base station 102 as described, for example with respect to FIGS. 1 and 2.

Communications device 1400 includes a processing system 1402 coupled to a transceiver 1408 (e.g., a transmitter and/or a receiver). Transceiver 1408 is configured to transmit (or send) and receive signals for the communications device 1400 via an antenna 1410, such as the various signals as described herein. Processing system 1402 may be configured to perform processing functions for communications device 1400, including processing signals received and/or to be transmitted by communications device 1400.

Processing system 1402 includes one or more processors 1420 coupled to a computer-readable medium/memory 1430 via a bus 1406. In certain aspects, computer-readable medium/memory 1430 is configured to store instructions (e.g., computer-executable code) that when executed by the one or more processors 1420, cause the one or more processors 1420 to perform the operations illustrated in FIGS. 4-13, or other operations for performing the various techniques discussed herein for PUCCH repetition.

In the depicted example, computer-readable medium/memory 1430 stores code 1431 for determining; and code 1432 for transmitting or receiving.

In the depicted example, the one or more processors 1420 include circuitry configured to implement the code stored in the computer-readable medium/memory 1430, including circuitry 1421 for determining; and circuitry 1422 for transmitting or receiving.

Various components of communications device 1400 may provide means for performing the methods described herein, including with respect to FIGS. 4-13.

In some examples, means for transmitting or sending (or means for outputting for transmission) may include the transceivers 232 and/or antenna(s) 234 of the base station 102 illustrated in FIG. 2 and/or transceiver 1408 and antenna 1410 of the communication device 1400 in FIG. 14.

In some examples, means for receiving (or means for obtaining) may include the transceivers 232 and/or antenna(s) 234 of the base station illustrated in FIG. 2 and/or transceiver 1408 and antenna 1410 of the communication device 1400 in FIG. 14.

In some examples, means for determining, means for transmitting, and means for receiving may include various processing system components, such as: the one or more processors 1420 in FIG. 14, or aspects of the base station 102 depicted in FIG. 2, including receive processor 238, transmit processor 220, TX MIMO processor 230, and/or controller/processor 240 (including uplink control information component 241).

Notably, FIG. 14 is just one example, and many other examples and configurations of communication device 1400 are possible.

### Example Clauses

Implementation examples are described in the following numbered clauses:

Clause 1. A method for wireless communication by a user-equipment (UE), comprising: receiving, from a base station (BS), a scheduling of a control channel resource set for transmission of an uplink control channel repetition; determining whether the uplink control channel repetition using the control channel resource set will be dropped; and transmitting, to the BS, the uplink control channel repetition on another control channel resource set based on the determination.

Clause 2. The method of Clause 1, wherein the uplink control channel repetition provides acknowledgment (ACK) or negative ACK (NACK) for a downlink data channel.

Clause 3. The method of Clause 2, wherein the downlink data channel is configured using semi-persistent scheduling (SP S).

Clause 4. The method of any one of Clauses 1-3, further comprising receiving downlink control information (DCI) configuring the uplink control channel repetition.

Clause 5. The method of any one of Clauses 1-4, wherein the received scheduling of the control channel resource set indicates a mapping of the control channel resource set to the other control channel resource set.

Clause 6. The method of any one of Clauses 1-5, wherein the other control channel resource set is in the same slot as the control channel resource set.

Clause 7. The method of any one of Clauses 1-6, further comprising receiving a group-common downlink control information (DCI) addressed to multiple UEs, the group-common DCI configuring the other control channel resource set for transmission of uplink control channel repetitions by the multiple UEs.

Clause 8. The method of any one of Clauses 1-7, wherein the other control channel resource set is scheduled for periodic channel state information (CSI) reporting.

Clause 9. The method of Clause 8, further comprising receiving DCI indicating a configuration for the uplink control channel repetition, the DCI further indicating the periodical CSI reporting.

Clause 10. The method of any one of Clauses 1-9, wherein the determining of whether the uplink control channel repetition will be dropped comprises determining whether the uplink control channel repetition will overlap with resources scheduled for another uplink transmission.

Clause 11. The method of Clause 10, wherein the other uplink transmission comprises ACK or NACK for a data channel configured using SPS.

Clause 12. The method of any one of Clauses 1-11, further comprising receiving, from the BS, an indication of cancellation of the uplink control channel repetition, wherein the determining of whether the uplink control channel repetition will be dropped comprises determining whether the uplink control channel repetition has been cancelled based on the indication from the BS.

Clause 13. The method of any one of Clauses 1-12, wherein: the uplink control channel repetition transmitted on other uplink control channel resource set is one of multiple uplink control channel repetitions; receiving the scheduling comprises receiving scheduling of the multiple uplink control channel repetitions; and at least one other uplink control channel repetition of the multiple uplink control channel repetitions is transmitted based on the received scheduling.

Clause 14. A method for wireless communication by a base station (BS), comprising: transmitting, to a user-equipment (UE), a scheduling of a control channel resource set for transmission of an uplink control channel repetition; determining whether the uplink control channel repetition using the control channel resource set will be dropped; and receiving, from the UE, the uplink control channel repetition on another control channel resource set based on the determination.

Clause 15. The method of Clause 14, wherein the uplink control channel repetition provides acknowledgment (ACK) or negative ACK (NACK) for a downlink data channel.

Clause 16. The method of Clause 15, wherein the downlink data channel is configured using semi-persistent scheduling (SP S).

Clause 17. The method of any one of Clauses 14-16, further comprising transmitting downlink control information (DCI) configuring the uplink control channel repetition.

Clause 18. The method of any one of Clauses 14-17, wherein the transmitted scheduling of the control channel resource set indicates a mapping of the control channel resource set to the other control channel resource set.

Clause 19. The method of any one of Clauses 14-18, wherein the other control channel resource set is in the same slot as the control channel resource set.

Clause 20. The method of any one of Clauses 14-19, further comprising transmitting a group-common downlink control information (DCI) addressed to multiple UEs, the group-common DCI configuring the other control channel resource set for transmission of uplink control channel repetitions by the multiple UEs.

Clause 21. The method of any one of Clauses 14-20, further comprising transmitting radio resource control (RRC) messages to multiple UEs, the RRC messages configuring the other control channel resource set for transmission of uplink control channel repetitions by the multiple UEs.

Clause 22. The method of any one of Clauses 14-21, wherein the other control channel resource set is scheduled for periodic channel state information (CSI) reporting.

Clause 23. The method of Clause 22, further comprising transmitting DCI indicating a configuration for the uplink control channel repetition, the DCI further indicating the periodical CSI reporting.

Clause 24. The method of any one of Clauses 14-23, wherein the determining of whether the uplink control channel repetition will be dropped comprises determining whether the uplink control channel repetition will overlap with resources scheduled for another uplink transmission.

Clause 25. The method of Clause 24, wherein the other uplink transmission comprises ACK or NACK for a data channel configured using SPS.

Clause 26. The method of any one of Clauses 14-25, further comprising transmitting, to the UE, an indication of cancellation of the uplink control channel repetition, wherein the determining of whether the uplink control channel repetition will be dropped comprises determining whether the uplink control channel repetition has been cancelled based on the indication from the BS.

Clause 27. The method of any one of Clauses 14-26, wherein: the uplink control channel repetition received on other uplink control channel resource set is one of multiple uplink control channel repetitions; transmitting the scheduling comprises transmitting scheduling of the multiple uplink control channel repetitions; and at least one other uplink control channel repetition of the multiple uplink control channel repetitions is received based on the scheduling.

Clause 28. An apparatus, comprising: a memory comprising executable instructions; one or more processors configured to execute the executable instructions and cause the apparatus to perform a method in accordance with any one of Clauses 1-27.

Clause 29. An apparatus, comprising means for performing a method in accordance with any one of Clauses 1-27.

Clause 30. A non-transitory computer-readable medium comprising executable instructions that, when executed by one or more processors of an apparatus, cause the apparatus to perform a method in accordance with any one of Clauses 1-27.

Clause 31. A computer program product embodied on a computer-readable storage medium comprising code for performing a method in accordance with any one of Clauses 1-27.

Clause 32. A method for wireless communication by a user-equipment (UE), comprising: determining that a scheduled transmission of uplink control information (UCI) on an uplink control channel will be dropped; and transmitting, to a base station (BS), at least a portion of the UCI on an uplink data channel based on the determination.

Clause 33. The method of Clause 32, wherein the UCI comprises a repetition of another UCI.

Clause 34. The method of any one of Clauses 32-33, wherein the UCI provides acknowledgment (ACK) or negative ACK (NACK) for a downlink data channel.

Clause 35. The method of Clause 34, wherein the downlink data channel is configured using semi-persistent scheduling (SPS).

Clause 36. The method of any one of Clauses 32-35, wherein the uplink data channel is configured using a configured grant.

Clause 37. The method of any one of Clauses 32-36, wherein the determining that the scheduled transmission will be dropped comprises determining that the UCI scheduled on the uplink control channel will overlap with resources scheduled for another uplink transmission.

Clause 38. The method of Clause 37, wherein the other uplink transmission comprises ACK or NACK for a data channel configured using SPS.

Clause 39. The method of any one of Clauses 32-38, further comprising receiving, from the BS, an indication of cancellation of the scheduled transmission of the UCI, wherein the determining that the scheduled transmission will be dropped comprises determining that the scheduled transmission of the UCI has been cancelled based on the indication from the BS.

Clause 40. The method of any one of Clauses 32-39, further comprising receiving downlink control information (DCI) configuring the UCI.

Clause 41. The method of Clause 40, wherein the DCI further indicates a transmission power to be used for transmitting the at least the portion of the UCI on the uplink data channel.

Clause 42. The method of any one of Clauses 32-41, further comprising: receiving radio resource control (RRC) signaling indicating a set of uplink control channel resources, each of the set of uplink control channel resources being mapped to a configured grant; and receiving DCI identifying one of the set of uplink control channel resources for the UCI, wherein the uplink data channel is associated with the configured grant mapped to the identified one of the set of uplink control channel resources.

Clause 43. The method of any one of Clauses 32-42, wherein the UCI is one of multiple UCI repetitions, wherein one or more other UCI repetitions of the multiple UCI repetitions are transmitted using one or more uplink control channels.

Clause 44. The method of any one of Clauses 32-43, wherein the uplink data channel comprises another UCI, wherein the at least the portion of the UCI and the other UCI are transmitted using different resources of the uplink data channel.

Clause 45. A method for wireless communication by a base station (BS), comprising: determining that a scheduled transmission of uplink control information (UCI) on an uplink control channel will be dropped; and receiving, from a user-equipment (UE), at least a portion of the UCI on an uplink data channel based on the determination.

Clause 46. The method of Clause 45, wherein the UCI comprises a repetition of another UCI.

Clause 47. The method of any one of Clauses 45-46, wherein the UCI provides acknowledgment (ACK) or negative ACK (NACK) for a downlink data channel.

Clause 48. The method of Clause 47, wherein the downlink data channel is configured using semi-persistent scheduling (SP S).

Clause 49. The method of any one of Clauses 45-48, wherein the uplink data channel is configured using a configured grant.

Clause 50. The method of any one of Clauses 45-49, wherein the determining that the scheduled transmission will be dropped comprises determining that the UCI scheduled on the uplink control channel will overlap with resources scheduled for another uplink transmission.

Clause 51. The method of Clause 50, wherein the other uplink transmission comprises ACK or NACK for a data channel configured using SPS.

Clause 52. The method of any one of Clauses 45-51, further comprising transmitting, to the UE, an indication of cancellation of the scheduled transmission of the UCI, wherein the determining that the scheduled transmission will be dropped comprises determining that the scheduled transmission of the UCI has been cancelled based on the indication from the BS.

Clause 53. The method of any one of Clauses 45-52, further comprising transmitting downlink control information (DCI) configuring the UCI.

Clause 54. The method of Clause 53, wherein the DCI further indicates a transmission power to be used for transmitting the at least the portion of the UCI on the uplink data channel.

Clause 55. The method of any one of Clauses 45-54, further comprising: transmitting radio resource control (RRC) signaling indicating a set of uplink control channel resources, each of the set of uplink control channel resources being mapped to a configured grant; and transmitting DCI identifying one of the set of uplink control channel resources for the UCI, wherein the uplink data channel is associated with the configured grant mapped to the identified one of the set of uplink control channel resources.

Clause 56. The method of any one of Clauses 45-55, wherein the UCI is one of multiple UCI repetitions, wherein one or more other UCI repetitions of the multiple UCI repetitions are received using one or more uplink control channels.

Clause 57. The method of any one of Clauses 45-56, wherein the uplink data channel comprises another UCI, wherein the at least the portion of the UCI and the other UCI are received using different resources of the uplink data channel.

Clause 58. An apparatus, comprising: a memory; and one or more processors coupled to the memory, the memory and the one or more processors being configured to perform a method in accordance with any one of Clauses 32-57.

Clause 59. An apparatus, comprising means for performing a method in accordance with any one of Clauses 32-57.

Clause 60. A non-transitory computer-readable medium comprising executable instructions that, when executed by one or more processors of an apparatus, cause the apparatus to perform a method in accordance with any one of Clauses 32-57.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). ABS for a macro cell may be referred to as a macro BS. ABS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as the wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of techniques for control information transmission on a data channel in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising: a memory comprising computer-executable instructions; and one or more processors configured to execute the computer-executable instructions and cause the UE to:
receive, from a network entity, a scheduling of a control channel resource set for transmission of an uplink control channel repetition;
determine whether the uplink control channel repetition using the control channel resource set will be dropped; and
transmit, to the network entity, the uplink control channel repetition on another control channel resource set based on the determination.

2. The apparatus of claim 1, wherein the control channel resource set comprises one or more control channel resources.

3. The apparatus of claim 1, wherein the uplink control channel repetition provides acknowledgment (ACK) or negative ACK (NACK) for a downlink data channel.

4. The apparatus of claim 3, wherein the downlink data channel is configured using semi-persistent scheduling (SPS).

5. The apparatus of claim 1, wherein the one or more processors are further configured to cause the UE to receive downlink control information (DCI) configuring the uplink control channel repetition.

6. The apparatus of claim 1, wherein the received scheduling of the control channel resource set indicates a mapping of the control channel resource set to the other control channel resource set.

7. The apparatus of claim 1, wherein the other control channel resource set is in a same slot as the control channel resource set.

8. The apparatus of claim 1, wherein the one or more processors are further configured to cause the UE to receive a group-common downlink control information (DCI) addressed to multiple UEs, the group-common DCI configuring the other control channel resource set for transmission of uplink control channel repetitions by the multiple UEs.

9. The apparatus of claim 1, wherein the other control channel resource set is scheduled for periodic channel state information (CSI) reporting.

10. The apparatus of claim 9, wherein the one or more processors are further configured to cause the UE to receive DCI indicating a configuration for the uplink control channel repetition, the DCI further indicating the periodic CSI reporting.

11. The apparatus of claim 1, wherein the determination of whether the uplink control channel repetition will be dropped comprises a determination of whether the uplink control channel repetition will overlap with resources scheduled for another uplink transmission.

12. The apparatus of claim 11, wherein the other uplink transmission comprises ACK or NACK for a data channel configured using SPS.

13. The apparatus of claim 1, wherein the one or more processors are further configured to cause the UE to receive, from the network entity, an indication of cancellation of the uplink control channel repetition, wherein the determination of whether the uplink control channel repetition will be dropped comprises a determination of whether the uplink control channel repetition has been cancelled based on the indication from the network entity.

14. The apparatus of claim 1, wherein:
the uplink control channel repetition transmitted on other uplink control channel resource set is one of multiple uplink control channel repetitions;
reception of the scheduling comprises reception of the scheduling of the multiple uplink control channel repetitions; and
at least one other uplink control channel repetition of the multiple uplink control channel repetitions is transmitted based on the received scheduling.

15. An apparatus for wireless communication at a user equipment (UE), comprising: a memory comprising computer-executable instructions; and one or more processors configured to execute the computer-executable instructions and cause the UE to:
determine that a scheduled transmission of uplink control information (UCI) on an uplink control channel will be dropped; and
transmit, to a network entity, at least a portion of the UCI on an uplink data channel based on the determination.

16. The apparatus of claim 15, wherein the UCI comprises a repetition of another UCI.

17. The apparatus of claim 15, wherein the UCI provides acknowledgment (ACK) or negative ACK (NACK) for a downlink data channel.

18. The apparatus of claim 17, wherein the downlink data channel is configured using semi-persistent scheduling (SPS).

19. The apparatus of claim 15, wherein the uplink data channel is configured using a configured grant.

20. The apparatus of claim 15, wherein the determination that the scheduled transmission will be dropped comprises a determination that the UCI scheduled on the uplink control channel will overlap with resources scheduled for another uplink transmission.

21. The apparatus of claim 20, wherein the other uplink transmission comprises ACK or NACK for a data channel configured using SPS.

22. The apparatus of claim 15, wherein the one or more processors are further configured to cause the UE to receive, from the network entity, an indication of cancellation of the scheduled transmission of the UCI, wherein the determination that the scheduled transmission will be dropped comprises a determination that the scheduled transmission of the UCI has been cancelled based on the indication from the network entity.

23. The apparatus of claim 15, wherein the one or more processors are further configured to cause the UE to receive downlink control information (DCI) configuring the UCI.

24. The apparatus of claim 23, wherein the DCI further indicates a transmission power to be used for transmitting the at least the portion of the UCI on the uplink data channel.

25. The apparatus of claim 15, wherein the one or more processors are further configured to cause the UE to:
receive radio resource control (RRC) signaling indicating a set of uplink control channel resources, each of the set of uplink control channel resources being mapped to a configured grant; and
receive DCI identifying one of the set of uplink control channel resources for the UCI, wherein the uplink data channel is associated with the configured grant mapped to the identified one of the set of uplink control channel resources.

26. The apparatus of claim 15, wherein the UCI is one of multiple UCI repetitions, wherein one or more other UCI repetitions of the multiple UCI repetitions are transmitted using one or more uplink control channels.

27. The apparatus of claim 15, wherein the uplink data channel comprises another UCI, wherein the at least the portion of the UCI and the other UCI are transmitted using different resources of the uplink data channel.

28. A method for wireless communication by a user-equipment (UE), comprising:
receiving, from a network entity, a scheduling of a control channel resource set for transmission of an uplink control channel repetition;
determining whether the uplink control channel repetition using the control channel resource set will be dropped; and
transmitting, to the network entity, the uplink control channel repetition on another control channel resource set based on the determination.

29. A method for wireless communication by a user-equipment (UE), comprising:
determining that a scheduled transmission of uplink control information (UCI) on an uplink control channel will be dropped; and
transmitting, to a network entity, at least a portion of the UCI on an uplink data channel based on the determination.
